(19) United States
(12) Patent Application Publication
(10) Pub. No.: US 2023/0205291 A1
(43) Pub. Date: Jun. 29, 2023

(54) SYSTEMS AND METHODS FOR POWERING ROBOTS

(71) Applicant: Sanctuary Cognitive Systems Corporation, Vancouver (CA)

(72) Inventor: Connor Richard Shannon, Vancouver (CA)

(21) Appl. No.: 18/089,517

(22) Filed: Dec. 27, 2022

Related U.S. Application Data
(60) Provisional application No. 63/293,973, filed on Dec. 27, 2021.

(51) Int. Cl. G06F 1/26; B25J 19/00

(52) U.S. Cl. CPC G06F 1/263; B25J 19/005

(57) ABSTRACT

In an implementation, a robotic system includes a robot, a power source exchange station, and a controller. A method of operation of the robotic system includes identifying by the controller a low-power condition of the robot, and, in response to the identifying of a low-power condition, causing by the controller the robot and the power source exchange station to exchange a first primary electrical power source from the robot for a second primary electrical power source from the power source exchange station. The first and the second primary electrical power source may be a first and a second primary battery, respectively. The robotic system may engage a secondary power source operable to maintain a power supply to the robot during the exchange. The secondary power source may be a secondary battery on-board the robot.

### TECHNICAL FIELD

The present systems, devices, and methods generally relate to powering robots, and particularly relate to replacing and/or replenishing depleted electrical power sources (e.g., batteries) for autonomous or semi-autonomous general purpose robots.

### BACKGROUND

Robots are machines that can assist humans or substitute for humans. Robots can be used in diverse applications including construction, manufacturing, monitoring, exploration, learning, and entertainment. Robots can be used in dangerous or uninhabitable environments, for example.

Some robots require user input, and can be operated by humans. Other robots have a degree of autonomy, and can operate, in at least some situations, without human intervention. Some autonomous or semi-autonomous robots are designed to mimic human behavior. Autonomous or semi-autonomous robots can be particularly useful in applications where robots (for example, general purpose robots) are needed to work for an extended time without operator intervention, to navigate within their operating environment, and/or to adapt to changing circumstances.

### BRIEF SUMMARY

A method of operation of a robotic system that comprises a robot, a power source exchange station, and a controller, may be summarized as comprising identifying by the controller a low-power condition of the robot, and, in response to the identifying of a low-power condition, causing by the controller the robot and the power source exchange station to exchange a first primary electrical power source from the robot for a second primary electrical power source from the power source exchange station. The robot may comprise at least one processor, and the identifying by the controller a low-power condition of the robot may include identifying by the at least one processor the low-power condition of the robot.

In some implementations, the causing by the controller the robot and the power source exchange station to exchange a first primary electrical power source from the robot for a second primary electrical power source from the power source exchange station includes causing by the controller the robot and the power source exchange station to exchange a first primary battery from the robot for a second primary battery from the power source exchange station. The identifying by the controller a low-power condition of the robot may include at least one of performing a capacity test to determine whether the first primary battery can support a desired current for a given length of time, or monitoring an internal resistance of one or more cells in the first primary battery.

In some implementations, the causing by the controller the robot and the power source exchange station to exchange a first primary electrical power source from the robot for a second primary electrical power source from the power source exchange station includes engaging by the robot a secondary power source, the secondary power source operable to maintain a power supply to the robot. The engaging by the robot a secondary power source may include engaging by the robot a secondary battery on-board the robot. The engaging by the robot a secondary power source may include electrically coupling by the robot to a power socket of the power source exchange station.

In some implementations, the power source exchange station is a mobile power source exchange station, and the causing by the controller the robot and the power source exchange station to exchange a first primary electrical power source from the robot for a second primary electrical power source from the power source exchange station includes directing the mobile power source exchange station by the controller to the robot.

In some implementations, the causing by the controller the robot and the power source exchange station to exchange a first primary electrical power source from the robot for a second primary electrical power source from the power source exchange station includes identifying by the robot a location of the power source exchange station, determining by the robot a route from a current location of the robot to the location of the power source exchange station, and relocating the robot by the robot from the current location of the robot to the location of the power source exchange station.

In some implementations, the causing by the controller the robot and the power source exchange station to exchange a first primary electrical power source from the robot for a second primary electrical power source from the power source exchange station includes disconnecting and removing by the robot the first primary power source, and installing by the robot the second primary power source.

In some implementations, the causing by the controller the robot and the power source exchange station to exchange a first primary electrical power source from the robot for a second primary electrical power source from the power source exchange station includes disconnecting and removing by the power source exchange station the first primary power source, and installing by the power source exchange station the second primary power source.

In some implementations, the method further comprises at least one of recharging or replenishing by the power source exchange station the first primary electrical power source.

A robot may be summarized as comprising a first primary electrical power source, the first primary electrical power source operable to power at least one electrical or electronic device of the robot, a controller comprising at least one processor, and at least one non-transitory processor-readable storage medium communicatively coupled to the at least one processor, the at least one non-transitory processor-readable storage medium storing processor-executable instructions and/or data that, when executed by the at least one processor, cause the robot to identify a low power condition of the first primary electrical power source, and, in response to the identifying of a low power condition, exchange the first primary electrical power source of the robot for a second primary electrical power source at a power source exchange station, the second primary electrical power source operable to power the at least one electrical device of the robot.

In some implementations, the first primary electrical power source is a first primary battery and the second primary electrical power source is a second primary battery.

In some implementations, the at least one non-transitory processor-readable storage medium storing processor-executable instructions and/or data that, when executed by the at least one processor, further cause the robot to engage a secondary power source, the secondary power source operable to maintain a power supply to the robot.

In some implementations, the at least one non-transitory processor-readable storage medium storing processor-executable instructions and/or data that, when executed by the at least one processor, further cause the robot to identify a location of the power source exchange station, determine a route from a current location of the robot to the location of the power source exchange station, and relocate the robot from the current location of the robot to the location of the power source exchange station.

A power source exchange station may be summarized as comprising a first primary electrical power source, the first primary electrical power source operable to power at least one electrical or electronic device of a robot, a controller comprising at least one processor, and at least one non-transitory processor-readable storage medium communicatively coupled to the at least one processor, the at least one non-transitory processor-readable storage medium storing processor-executable instructions and/or data that, when executed by the at least one processor, cause the power source exchange station to identify a low power condition of a second primary electrical power source of a robot, the second primary electrical power source operable to power the at least one electrical or electronic device of the robot, and, in response to the identifying of a low power condition, exchange the first primary electrical power source of the power source exchange station for the second primary electrical power source of the robot.

In some implementations, the first primary electrical power source is a first primary battery and the second primary electrical power source is a second primary battery.

In some implementations, the at least one non-transitory processor-readable storage medium storing processor-executable instructions and/or data that, when executed by the at least one processor, further cause the power source exchange station to engage a secondary power source with the robot, the secondary power source operable to maintain a power supply to the robot.

In some implementations, the power source exchange station is a mobile power source exchange station, and the at least one non-transitory processor-readable storage medium storing processor-executable instructions and/or data that, when executed by the at least one processor, further cause the power source exchange station to identify a location of the robot, determine a route from a current location of the power source exchange station to the location of the robot, and relocate the power source exchange station from the current location of the power source exchange station to the location of the robot.

### BRIEF DESCRIPTION OF THE SEVERAL VIEWS OF THE DRAWINGS

The various elements and acts depicted in the drawings are provided for illustrative purposes to support the detailed description. Unless the specific context requires otherwise, the sizes, shapes, and relative positions of the illustrated elements and acts are not necessarily shown to scale and are not necessarily intended to convey any information or limitation. In general, identical reference numbers are used to identify similar elements or acts.

FIG. 1 is a schematic diagram of an example implementation of a robot with an electrical power source, in accordance with the present systems, devices, and methods.

FIG. 2 is a block diagram of an example implementation of a power source exchange station, in accordance with the present systems, devices, and methods.

FIG. 3 is a block diagram of an example implementation of a robotic system with a robot and a power source exchange station, in accordance with the present systems, devices, and methods.

FIG. 4A is a flow chart of an example method of operation of a robotic system, in accordance with the present systems, devices, and methods.

FIG. 4B is a flow chart of an example method for exchanging a primary power source of a robot at a power source exchange station, in accordance with the present systems, devices, and methods.

### DETAILED DESCRIPTION

The following description sets forth specific details in order to illustrate and provide an understanding of various implementations and embodiments of the present systems, devices, and methods. A person of skill in the art will appreciate that some of the specific details described herein may be omitted or modified in alternative implementations and embodiments, and that the various implementations and embodiments described herein may be combined with each other and/or with other methods, components, materials, etc. in order to produce further implementations and embodiments.

In some instances, well-known structures and/or processes associated with computer systems and data processing have not been shown or provided in detail in order to avoid unnecessarily complicating or obscuring the descriptions of the implementations and embodiments.

Unless the specific context requires otherwise, throughout this specification and the appended claims the term “comprise” and variations thereof, such as “comprises” and “comprising,” are used in an open, inclusive sense to mean “including, but not limited to.”

Unless the specific context requires otherwise, throughout this specification and the appended claims the singular forms “a,” “an,” and “the” include plural referents. For example, reference to “an embodiment” and “the embodiment” include “embodiments” and “the embodiments,” respectively, and reference to “an implementation” and “the implementation” include “implementations” and “the implementations,” respectively. Similarly, the term “or” is generally employed in its broadest sense to mean “and/or” unless the specific context clearly dictates otherwise.

The headings and Abstract of the Disclosure are provided for convenience only and are not intended, and should not be construed, to interpret the scope or meaning of the present systems, devices, and methods.

The technology described in the present application includes systems, devices, and methods for autonomous or semi-autonomous swapping of electrical power sources (e.g., batteries) between a robot and a repository of compatible electrical power sources. When an electrical power source of a robot is in a low-power condition, the technology provides for autonomous or semi-autonomous replacement, recharging, and/or replenishment of the electrical power source, so that the robot can perform its task with little or no interruption to the task, and with little or no human intervention.

### Power Sources for Robots

A robotic system typically includes at least one power source. Robotic systems generally include an electrical power source. A hydraulic robot may include motors, pumps, sensors, controllers, and/or processor that are powered by an electrical power source. Some robots can be tethered to a source of electrical power without affecting their functionality. Other robots are untethered and have an on-board source of electrical power, for example a battery, a fuel cell, or a supercapacitor.

Some on-board sources of electrical power rely on a charge or a fuel which is depleted over time, and consequently have a need for periodic recharging, replenishment, and/or replacement.

An advantage of using a general purpose robot to perform a task is that the robot can typically work longer hours than a human performing the same task. In some situations, the robot can perform a task without taking a break, i.e., 24/7. It can therefore be desirable for the robotic system to be operable to recharge, replenish, and/or replace a power source of the robot without causing a significant interruption to the robot’s task, i.e., without causing the robot to be idle while the power source is recharged, replenished, and/or replaced.

An advantage of an autonomous robot is that it can operate with little or no human oversight, or intervention, during performance of the robot’s task. It can be desirable for the robot to be similarly autonomous during recharging, replenishment, and/or replacement of an electrical power source.

### Robot With Electrical Power Source

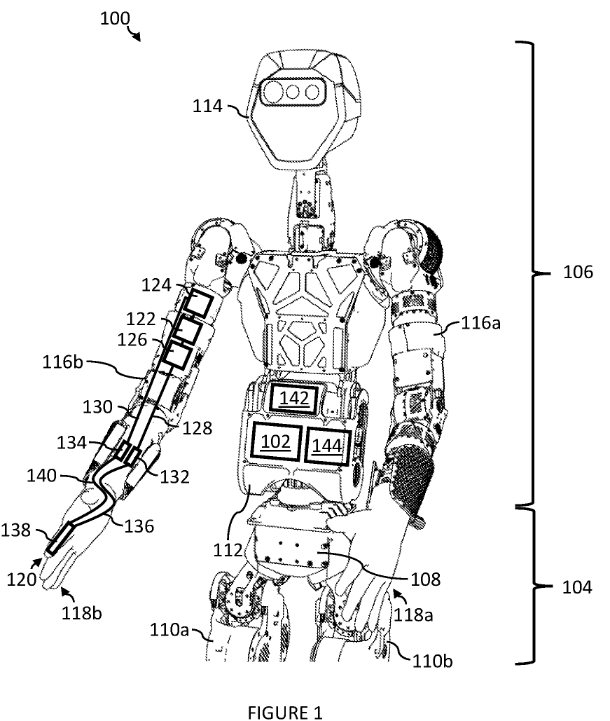

FIG. 1 is a schematic diagram of an example implementation of a robot 100 with an electrical power source 102, in accordance with the present systems, devices, and methods. Robot 100 may be autonomous or semi-autonomous. Robot 100 may be a general purpose robot. Electrical power source 102 may be at least of a battery, a fuel cell, or a supercapacitor.

Robot 100 comprises a base 104 and a humanoid upper body 106. Base 104 comprises a pelvic region 108 and two legs 110a and 110b (collectively referred to as legs 110). Only the upper portion of legs 110 is shown in FIG. 1. In other example implementations, base 104 may comprise a stand and (optionally) one or more wheels.

Upper body 106 comprises a torso 112, a head 114, a left-side arm 116a and a right-side arm 116b (collectively referred to as arms 116), and a left hand 118a and a right hand 118b (collectively referred to as hands 118). Arms 116 of robot 100 are also referred to in the present application as robotic arms. Arms 116 of robot 100 are humanoid arms. In other implementations, arms 116 have a form factor that is different from a form factor of a humanoid arm.

Hands 118 are also referred to in the present application as end effectors. In other implementations, hands 118 have a form factor that is different from a form factor of a humanoid hand. Each of hands 118 comprises one or more digits, for example, digit 120 of hand 118b. Digits may include fingers, thumbs, or similar structures of the hand or end effector.

In some implementations, robot 100 is a hydraulically-powered robot. Components of a hydraulic control system may be housed, for example, in base 104 and/or torso 112 of upper body 106. Components of the hydraulic control may also be located outside the robot, e.g., on a wheeled unit that rolls with the robot as it moves around, or in a fixed station to which the robot is tethered. In the implementation of FIG. 1, robot 100 includes a hydraulic pump 122, a reservoir 124, and an accumulator 126 integrated with arm 116b of robot 100.

Robot 100 further comprises hoses 128 and 130. Hose 128 provides a hydraulic coupling between accumulator 126 and a pressure valve 132. Hose 130 provides a hydraulic coupling between an exhaust valve 134 and reservoir 124. Robot 100 further comprises hose 136 which runs from pressure valve 132 to actuation piston 138, and hose 140 which runs to exhaust valve 134 from actuation piston 138. Hoses 128 and 136, and pressure valve 132, provide a forward path to actuation piston 138. Hoses 130 and 140, and exhaust valve 134 provide a return path from actuation piston 138. The hydraulic fluid in the hydraulic hoses of FIG. 1 (including hoses 128 and 130) can be an oil, for example, peanut oil or mineral oil.

Pressure valve 132 and exhaust valve 134 can control actuation piston 138, and can cause actuation piston 138 to move, which can cause a corresponding motion of at least a portion of hand 118b, for example, digit 120.

In some implementations, pressure valve 132 and exhaust valve 134 are electrohydraulic servo valves controlled by a controller 142. The electrohydraulic servo valves are also referred to in the present application as servo valves and servo-controlled valves. Controller 142 may be implemented by any suitable combination of hardware, software, and/or firmware. Controller 142 may include, for example one or more application-specific integrated circuit(s), standard integrated circuit(s), and/or computer program(s) executed by any number of computers, microcontrollers, and/or processors (including, e.g., microprocessors, central processing units). In other implementations, other suitable types of valves may be used.

Pump 122, pressure valve 132, and exhaust valve 134 are examples of components of the hydraulic control system of robot 100 that can be powered by electrical power source 102. Controller 142 is an example of an electronic system that can also be powered by electrical power source 102.

In other implementations, the hydraulic drive mechanism includes a motor and a drive piston. The motor and the drive piston are further examples of components of robot 100 that can be powered by electrical power source 102. In other implementations, robot 100 is an electromechanical robot. In yet other implementations, robot 100 is a cable-driven robot.

Electrical power source 102 may be a primary electrical power source. A primary electrical power source is an electrical power source used by robot 100 in normal operation to power electrical and/or electronic components of robot 100 (for example, pump 122 and controller 142).

FIG. 1 shows a single primary electrical power source 102. Those of skill in the art will appreciate that robot 100 may include more than one primary electrical power source. In some implementations, each primary electrical power source is dedicated to a respective designated subset of electrical or electronic components on robot 100. In some implementations, multiple primary power sources may included to provide redundancy in the event of a failure of one primary power source.

Robot 100 also includes a secondary power source 144. A secondary power source of robot 100 (for example, secondary power source 144) is an electrical power source that can be engaged by robot 100 (or by another element of a robotic system of which robot 100 is a part) to maintain electrical power to electrical and/or electronic components of robot 100 when a primary electrical power source (for example electrical power source 102) is unavailable. The primary electrical power source may be unavailable, for example, when the present electrical power source is being swapped for a replacement primary electrical power source. The secondary power source may have a lower capacity than the primary power source. Secondary power source 144 may be a secondary battery, for example. In some implementations, secondary power source 144 may include a tethered connector port, such as a female connector socket or a male connector plug, for electrically coupling to a corresponding tethered connector port of a power source exchange station as described in more detail later on.

In some implementations, a robot with an integrated hydraulic system, such as robot 100 of FIG. 1, may employ any or all of the teachings of U.S. Pat. Application Serial No. 17/749,536, which is incorporated herein by reference in its entirety.

### Power Source Exchange Station

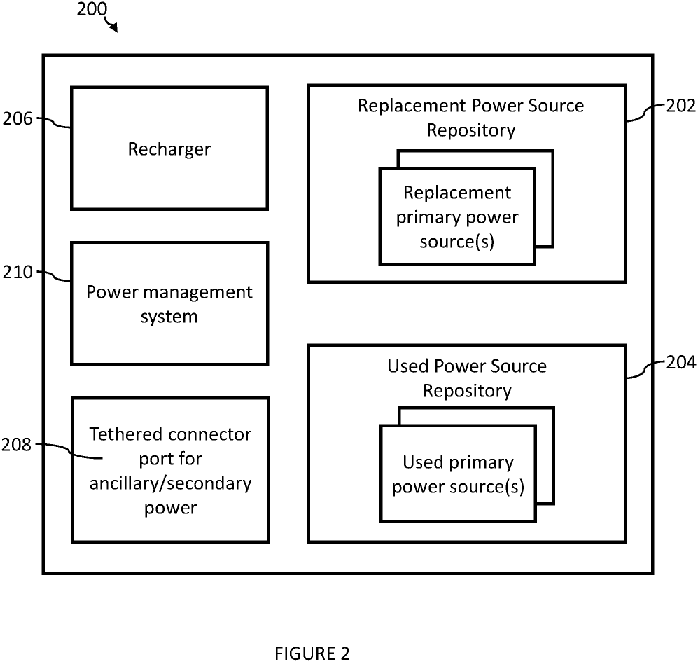

FIG. 2 is a block diagram of an example implementation of a power source exchange station 200, in accordance with the present systems, devices, and methods.

Power source exchange station 200 includes a replacement power source repository 202 which includes one or more replacement primary electrical power sources compatible with at least one robot (e.g., robot 100 of FIG. 1). Power source exchange station 200 also includes a used power source repository 204 which includes one or more used, depleted, or discharged primary electrical power sources received from at least one robot (e.g., robot 100 of FIG. 1).

Power source exchange station 200 may include a recharger. The recharger may be suitable for recharging a primary electrical power source (e.g., a battery) from a robot.

Power source exchange station 200 may include a tethered connector port 208 for ancillary electrical power. Tethered connector port 208 may provide DC power. Tethered connector port 208 may be used to provide secondary power to a robot while the robot is exchanging a primary power source with power source exchange station 200. Tethered connector port 208 may be used to provide secondary power to a robot while the robot is recharging (or otherwise waiting for) a primary power source. In some implementations, the tethered connector port 208 of the robot may include a tethered male connector plug and the power source exchange station may include a corresponding female connector socket, whereas in other implementations tethered connector port 208 of the robot may include a female connector socket and the power source exchange station may include a corresponding tethered male connector plug. In either case, electrically coupling the tethered male connector plug and the female connector socket may provide secondary electrical power from the power source exchange station to the robot during the exchange of a first (drained) primary power source from the robot for a second (full) primary power source from the power source exchange station.

Power source exchange station 200 may include a power management system 210. Power management system 210 may include at least one processor. In some implementations (for example, when the robot is unable to identify for itself a condition of the robot’s primary power source), power management system 210 may be used to identify a low-power condition in a robot. Power management system 210 may be used to provide an automated exchange of primary power source with a robot, including engaging and disengaging a source of secondary power to maintain power to the robot during the exchange.

### Robotic System With Robot and Power Source Exchange Station

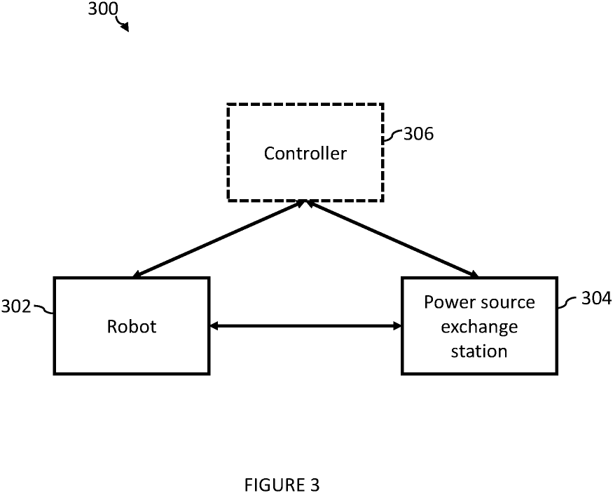

FIG. 3 is a block diagram of an example implementation of a robotic system 300 with a robot 302 and a power source exchange station 304.

Robot 302 may be a general purpose robot. Robot 302 may be an autonomous or semi-autonomous robot. Robot 302 has a primary electrical power source. The primary electrical power source may be on-board robot 302. The primary electrical power source may be a battery, fuel cell, or supercapacitor, for example. The primary electrical power source may power one or more electrical or electronic components on-board the robot.

Power source exchange station 304 may be a mobile or a fixed station. Power source exchange station 304 may include a repository of one or more replacement primary electrical power sources that are compatible with robot 302 and interchangeable with the primary electrical power source of robot 302. Power source exchange station 304 may include a recharger. Power source exchange station 304 may include a source of fuel, for example, hydrogen or methanol for a fuel cell. Power source exchange station 304 may install a replacement fuel tank on robot 302, or may add fuel to a fuel tank already installed on robot 302.

Robotic system 300 may exchange a primary electrical power source on-board robot 302 for a replacement primary electrical power source in the repository of power source exchange station 304. Robotic system 300 may initiate this exchange when a low-power condition in the primary electrical power source on-board robot 302 is identified.

Robotic system 300 optionally includes a standalone controller 306 (indicated by dotted lines in FIG. 3). Controller 306 may identify a low-power condition of a primary electrical power source and/or cause an exchange of the primary electrical power source of robot 302 for a replacement primary electrical power source at power source exchange station 304.

### Battery-Swapping Implementation

In some implementations, the technology described in the present application automatically swaps a discharged battery in the robot for a new or recharged battery at a battery-swapping station.

When the robot identifies a low-battery condition, it proceeds to the battery-swapping station. A low-battery condition may be identified by a battery management system on-board the robot, for example. A low-battery condition may be identified, for example, by monitoring a remaining capacity of the battery. In some implementations, a battery system may perform a capacity test to determine whether the battery can support a desired current for a given length of time. In other implementations, a low-battery condition is identified by monitoring an internal resistance of one or more cells in the battery. In some implementations, a low-battery condition is inferred by analyzing a trend in a performance metric of the battery. In some implementations, the robotic system anticipates the low-battery condition, and initiates an exchange before the low-battery condition is reached. While the above text refers to a low-battery condition, it will be appreciated by those of skill in the art that an equivalent condition can be identified and acted upon for other electrical power sources (e.g., fuel cells and supercapacitors).

In some implementations, battery-swapping by the robot and the battery-swapping station is performed autonomously, i.e., with little or no human intervention. In some implementations, a secondary power source is engaged to provide power to the robot while the battery is being swapped and power from either the battery being replaced or the replacement battery is temporarily unavailable. The secondary power source may be a secondary battery on-board the robot, for example. It may be sufficient for the secondary battery to provide about five (5) minutes of power. In some implementations, the secondary battery can be recharged by the primary battery.

The secondary power source may be a DC supply via an electrical coupling between the battery-swapping station and the robot. In some implementations, the robot includes a socket on-board the robot to receive a tethered connection to a source of electrical power located at the battery swapping station.

### Methods of Operation of a Robotic System

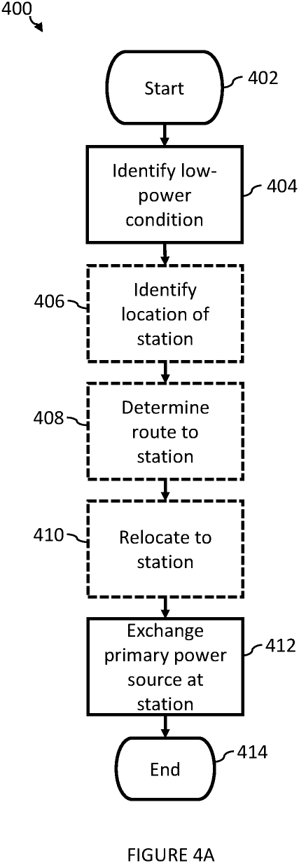

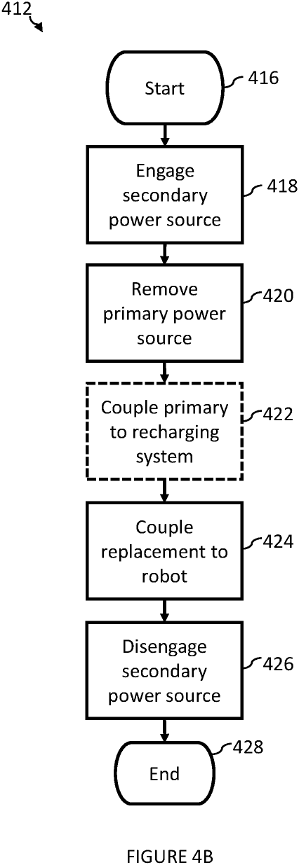

FIG. 4A is a flow chart of an example method of operation 400 of a robotic system, in accordance with the present systems, devices, and methods. Method 400 of FIG. 4A includes seven (7) acts 402, 404, 406, 408, 410, 412, and 414. Those of skill in the art will appreciate that in alternative implementations certain acts of FIG. 4A may be omitted and/or additional acts may be added. Those of skill in the art will also appreciate that the illustrated order of the acts is shown for exemplary purposes only and may change in alternative implementations.

At 402, in response to a starting condition (e.g., a controller powering up), the method starts. At 404, the robotic system identifies a low-power condition. In some implementations, the robot identifies the low-power condition. In other implementations, a power source exchange station identifies the low-power condition. In yet other implementations, the low-power condition is identified by a controller separate to both the robot and the power source exchange station.

The low-power condition indicates the robot needs to replace, recharge, or replenish its primary electrical power source. The low-power condition may be identified, for example, by monitoring an internal condition of the power source, as described above for the example of a battery.

Acts 406, 408, and 410 are optional, as indicated by the dotted lines. At 406, the robotic system identifies a location of a power source exchange station. If there are multiple power source exchange stations, the power source exchange station identified at 406 may be the one closest to a current location of the robot, for example. At 408, the robotic system determines at least one route from the robot’s current location to the location of the power source exchange station. At 410, the robotic system causes the robot to re-locate to the location of the power source exchange station via one of the determined routes. In some implementations, acts 406, 408, and 410 are performed by at least one processor on-board the robot.

At 412, the robotic system exchanges a primary electrical power source on-board the robot for a replacement, recharged, or replenished electrical power source from the power source exchange station. At 418, method 400 ends, for example, when the robot leaves the power source exchange station and returns to its task.

In some implementations, the robotic system installs an additional power source on-board the robot. This may be instead of, or in addition to, replacing a power source that has a low-power condition.

In some implementations, the robot’s primary electrical power source is on-board the robot. The robot may be mobile and/or untethered. In other implementations, the robot is tethered to a primary electrical power source. For example, the robot may be mobile and the power source may be fixed.

FIG. 4B is a flow chart of an example method of implementation of act 412 of FIG. 4A for exchanging a primary power source of a robot at a power source exchange station, in accordance with the present systems, devices, and methods. Method 412 of FIG. 4B includes seven (7) acts 416, 418, 420, 422, 424, 426, and 428. Those of skill in the art will appreciate that in alternative implementations certain acts of FIG. 4B may be omitted and/or additional acts may be added. Those of skill in the art will also appreciate that the illustrated order of the acts is shown for exemplary purposes only and may change in alternative implementations.

At 416, in response to a starting condition (e.g., the robot arriving at the power source exchange station), the method starts. At 418, the robotic system engages a temporary secondary power source for the robot. In some implementations, the robot switches to a secondary battery on-board the robot. In other implementations, the robot electrically couples to a power supply provided by the power source exchange station, for example, a DC supply from an AC/DC converter that is electrically coupled to a mains supply at the power source exchange station.

At 420, the robotic system removes the robot’s primary power source. In some implementations, the robot removes its primary battery.

Optionally (as indicated by the dotted lines), at 422, the robotic system electrically couples the robot’s removed primary power source to a recharging or replenishment system, and commences recharging/replenishing. For example, if the robot’s primary power source is a battery, then the robotic system may electrically couple the battery to a battery charger, and initiate a recharging cycle.

At 424, the robotic system electrically couples a replacement primary power source to the robot. The replacement primary power source may, for example, be a fully-charged battery compatible with the robot. At 426, the robotic system disengages the secondary power source. At 428, the method ends, for example, when the robot leaves the power source exchange station and returns to its task.

In some implementations, the robot is a humanoid robot having one or more hands, and able to move on legs and/or wheels. In some implementations, the robot performs the acts described with reference to FIG. 4B. These may include, for example, disconnecting and removing the primary power source, delivering it to the power source exchange station, identifying a compatible replacement primary power source at the power source exchange station, and installing the replacement primary power source in the robot. The primary power source may be a battery, and the replacement may be a new or fully-charged battery. In some implementations, the robot is autonomous or semi-autonomous. In some implementations, the robot is a general purpose robot, and swapping the robot’s primary electrical power source is one of the robot’s functions. In some implementations, where the robot is an autonomous or semi-autonomous humanoid robot, the robot includes one or more hands (i.e., humanoid end effectors, for example, hands 118 of robot 100 of FIG. 1), and the robot can use its hands to perform acts described above with reference to FIG. 4B. The robot may, for example, use its hands to disconnect and remove the primary power source, deliver it to the power source exchange station, select a replacement, and/or install and connect the replacement.

In some implementations, the power source exchange station is automated, and able to perform at least some of the acts described with reference to FIG. 4B. These may include, for example, disconnecting and removing the primary power source from the robot, and installing a replacement primary power source in the robot.

In some implementations, the robot and the power source exchange station are both able to perform at least some of the acts described with reference to FIG. 4B. For example, the robot may disconnect the primary power source, and the power source exchange station may remove and replace it by a replacement power source, before the robot completes the reconnection of the replacement power source.

In some implementations, the robot is mobile and the power source exchange station is at a fixed location. In other implementations, the power source exchange station is mobile and able to be directed to a robot that has a present or impending low-power condition.

Throughout this specification and the appended claims, infinitive verb forms are often used. Examples include, without limitation: “to provide,” “to control,” and the like. Unless the specific context requires otherwise, such infinitive verb forms are used in an open, inclusive sense, that is as “to, at least, provide,” “to, at least, control,” and so on.

This specification, including the drawings and the abstract, is not intended to be an exhaustive or limiting description of all implementations and embodiments of the present systems, devices, and methods. A person of skill in the art will appreciate that the various descriptions and drawings provided may be modified without departing from the spirit and scope of the disclosure. In particular, the teachings herein are not intended to be limited by or to the illustrative examples of robotic systems and hydraulic circuits provided.

The claims of the disclosure are below. This disclosure is intended to support, enable, and illustrate the claims but is not intended to limit the scope of the claims to any specific implementations or embodiments. In general, the claims should be construed to include all possible implementations and embodiments along with the full scope of equivalents to which such claims are entitled.

1. A method of operation of a robotic system, the robotic system comprising a robot, a power source exchange station, and a controller, the method comprising:
identifying, by the controller, a low-power condition of the robot; and
in response to the identifying of a low-power condition, causing, by the controller, the robot and the power source exchange station to exchange a first primary electrical power source from the robot for a second primary electrical power source from the power source exchange station.

2. The method of claim 1, wherein the robot comprises at least one processor, and wherein the identifying by the controller a low-power condition of the robot includes identifying by the at least one processor the low-power condition of the robot.

3. The method of claim 1 wherein identifying by the at least one processor the low-power condition of the robot includes autonomously identifying the low-power condition of the robot by the at least one processor of the robot.

4. The method of claim 1, wherein the causing by the controller the robot and the power source exchange station to exchange a first primary electrical power source from the robot for a second primary electrical power source from the power source exchange station includes causing by the controller the robot and the power source exchange station to exchange a first primary battery from the robot for a second primary battery from the power source exchange station.

5. The method of claim 4, wherein the identifying by the controller a low-power condition of the robot includes at least one of performing a capacity test to determine whether the first primary battery can support a desired current for a given length of time, or monitoring an internal resistance of one or more cells in the first primary battery.

6. The method of claim 1, wherein the causing by the controller the robot and the power source exchange station to exchange a first primary electrical power source from the robot for a second primary electrical power source from the power source exchange station includes engaging by the robot a secondary power source, the secondary power source operable to maintain a power supply to the robot.

7. The method of claim 6, wherein the engaging by the robot a secondary power source includes engaging by the robot a secondary battery on-board the robot.

8. The method of claim 6, wherein the engaging by the robot a secondary power source includes electrically coupling, by the robot, a tethered connector port of the robot to a corresponding tethered connector port of the power source exchange station.

9. The method of claim 8, wherein electrically coupling, by the robot, a tethered connector port of the robot to a corresponding tethered connector port of the power source exchange station includes electrically coupling, by the robot, a tethered male connector plug of the robot to a female connector socket of the power source exchange station.

10. The method of claim 8, wherein electrically coupling, by the robot, a tethered connector port of the robot to a corresponding tethered connector port of the power source exchange station includes electrically coupling, by the robot, a female connector socket of the robot to a tethered male connector plug of the power source exchange station.

11. The method of claim 1, wherein the power source exchange station is a mobile power source exchange station, and wherein the causing by the controller the robot and the power source exchange station to exchange a first primary electrical power source from the robot for a second primary electrical power source from the power source exchange station includes directing the mobile power source exchange station by the controller to the robot.

12. The method of claim 1, wherein the causing by the controller the robot and the power source exchange station to exchange a first primary electrical power source from the robot for a second primary electrical power source from the power source exchange station includes:
identifying by the robot a location of the power source exchange station;
determining by the robot a route from a current location of the robot to the location of the power source exchange station; and
relocating the robot by the robot from the current location of the robot to the location of the power source exchange station.

13. The method of claim 1, wherein the causing by the controller the robot and the power source exchange station to exchange a first primary electrical power source from the robot for a second primary electrical power source from the power source exchange station includes:
disconnecting and removing by the robot the first primary power source; and
installing by the robot the second primary power source.

14. The method of claim 1, wherein the causing by the controller the robot and the power source exchange station to exchange a first primary electrical power source from the robot for a second primary electrical power source from the power source exchange station includes:
disconnecting and removing by the power source exchange station the first primary power source;
and installing by the power source exchange station the second primary power source.

15. The method of claim 1, further comprising at least one of recharging or replenishing by the power source exchange station the first primary electrical power source.

16. The method of claim 1 wherein the robot comprises the controller, and wherein identifying by the controller a low-power condition of the robot includes autonomously identifying the low-power condition of the robot by the robot.

17. The method of claim 1 wherein the robot comprises at least one processor, and wherein, causing, by the controller, the robot and the power source exchange station to exchange a first primary electrical power source from the robot for a second primary electrical power source from the power source exchange station includes autonomously exchanging a first primary electrical power source from the robot for a second primary electrical power source from the power source exchange station by the robot.

18. The method of claim 1 wherein the robot comprises the controller, and wherein, causing, by the controller, the robot and the power source exchange station to exchange a first primary electrical power source from the robot for a second primary electrical power source from the power source exchange station includes autonomously exchanging a first primary electrical power source from the robot for a second primary electrical power source from the power source exchange station by the robot.
